(19) United States
(12) Patent Application Publication
(10) Pub. No.: US 2026/0329905 A1
(43) Pub. Date: Oct. 22, 2026

(54) Dynamic Domain Retrieval-Augmented Generation System with Continuous Learning and Goal Inference

(71) Applicant: Brillient Corporation, Reston, VA (US)

(72) Inventors: Richard Jacik, Lansdowne, VA (US); Fardin Ahsan Sakib, Fairfax, VA (US)

(73) Assignee: Brillient Corporation, Reston, VA (US)

(21) Appl. No.: 19/183,682

(22) Filed: Apr. 18, 2025

(51) Int. Cl. G06F 16/3332; G06F 16/334

(52) U.S. Cl. CPC G06F 16/3334; G06F 16/3344

(57) ABSTRACT

A system receives a user query associated with a data domain and determines, for at least one term or phrase in the user query, a domain-specific synonym associated with the data domain. At least one distilled or alternative query is generated that includes a rewording of all or a portion of the user query using the domain-specific synonym. A subset of available data sources to search is determined based at least in part on the data domain. By searching the subset of the available data sources, a set of files is identified that is relevant to the user query and/or the alternative query. Relevant portions or chunks of the set of files are then identified. A natural language response to the query is determined based on the relevant portions and presented to the user along with citations to the data files and/or data portions used to generate the response.

### TECHNICAL FIELD

The present disclosure relates generally to retrieval-augmented generation. More specifically, in some embodiments, the present disclosure relates to a dynamic domain retrieval-augmented generation system with continuous learning and goal inference.

### BACKGROUND

A large language model (LLM) is a type of machine learning model. LLMs are designed for natural language processing, for example, to receive a language input and provide a corresponding response in the natural language. For instance, LLMs have been developed for translating, classifying, and generating text and for answering questions in a conversational manner. Retrieval-augmented generation (RAG) is an artificial intelligence (AI) framework that can improve the accuracy and relevance of LLM responses by retrieving information by performing indexed searches on knowledge sources, such as the internet, before text, or other output, is generated. As an example, a RAG system may be developed to allow employees at a company or government agency to provide a request for information in their natural language and receive requested information based on information available to the RAG. However, previous RAG technology suffers from various problems and limitations, as explained further below, such that there exists a need for improved RAG technology.

### SUMMARY

This disclosure encompasses the recognition that previous RAG LLM technology suffers from various technological problems and disadvantages. For example, current LLMs have fixed knowledge cutoff dates and cannot access up-to-date information without complete retraining. Retraining entire models is computationally expensive and resource-intensive. Information can become quickly outdated in rapidly evolving domains, such as medical research, current events, etc. As another example, LLMs often generate plausible-sounding but factually incorrect information (referred to as hallucinations). Without direct grounding in authoritative sources, these models can make confident assertions of false information. It is difficult for users to verify accuracy without examining model internals or already knowing the correct answer to a question posed to the LLM. Current RAG implementations mitigate these problems in a very limited manner.

As yet another example, previous RAG systems use fixed-size document segmentation that ignores semantic boundaries, resulting in lost context and information fragmentation. Critical relationships between concepts can be severed across the boundaries of segmented files. As still another example, most previous RAG systems operate as walled gardens optimized for single domains and cannot be optimized easily for any other domain without substantial changes. As another example, previous RAG implementations lack mechanisms for adapting to changing query patterns or user needs over time. As a final example, previous RAG systems are typically evaluated and trained based on the narrow focus of factual correctness. This approach omits consideration of how effectively the systems help users accomplish their actual goals and perform complex multi-step tasks.

The present disclosure describes an improved RAG system and associated methods that overcome the limitations of previous RAG technology through dynamic, goal-oriented information retrieval and response generation. The systems and methods of this disclosure may support multiple interaction modes, including guided exploration. The systems and methods of this disclosure may utilize domain-aware query processing and context tuning, enabling specialized and effective information retrieval across varied knowledge domains with dynamically adjustable parameters based on the specific context or data domain of a query.

The systems and methods of this disclosure may use a goal-driven learning framework that identifies user intent beyond simply relying on the text of the queries. For instance, queries may be mapped to specific goals within domains, and a database of domain-goal-action relationships may be developed and maintained/updated with weighted outcomes. In some embodiments, the systems and methods of this disclosure implement advanced query distillation techniques that break complex queries into manageable sub-queries, identify key concepts and their relationships, and generate distilled or alternative queries using domain-specific synonyms.

The systems and methods of this disclosure may use a specialized source learning algorithm that maintains credibility scores for information sources, tracks the quality of individual objects within sources, and dynamically adjusts source rankings based on feedback and performance. The quality of query responses and the efficiency of obtaining these responses may be improved by limiting searches to higher ranked sources.

In some embodiments, the systems and methods of this disclosure provide intelligent data segmentation or “chunking” with semantic boundary preservation and/or employ a multi-stage retrieval process with scope and deep search capabilities to effectively and efficiently retrieve relevant information.

In accordance with the above, certain embodiments of this disclosure may be integrated into the practical application of systems and methods that improve the performance, reliability, and/or efficiency of RAG.

In an aspect, the disclosure proves a system comprising at least one processor configured to: receive a user query associated with a data domain; determine, for at least one term or phrase in the user query, a domain-specific synonym associated with the data domain; generate at least one alternative query comprising a rewording of all or a portion of the user query using the domain-specific synonym; determine a subset of available data sources to search based at least in part on the data domain; determine, by searching the subset of the available data sources, a set of files relevant to at least one of (i) the user query or (ii) the at least one alternative query; identify portions of the set of files relevant to at least one of the user query or the at least one alternative query; generate a natural language response based on the relevant portions of the set of files; and provide a response to the user query, the response comprising the natural language response and citations to the relevant portions of the set of files.

In some embodiments, the processor is further configured to: predict a goal associated with the user query; and determine the subset of available data sources to search based at least in part on the data domain and the predicted goal. In some embodiments, the processor is further configured to: determine a credibility score for each data source based on past search results; and determine the subset of available data sources to search based at least in part on the data domain and the credibility score of each data source. In some embodiments, the processor is further configured to determine the set of files from the subset of available data sources as a ranked list based on the credibility score of the data source from which each file of the set of files was obtained. In some embodiments, the processor is further configured to determine the credibility score for each data source based on actions taken by user after previous results were provided based on information from the data source.

In some embodiments, the processor is further configured to segment each file in the set of files into chunks, each chunk comprising information associated with a predefined context. In some embodiments, the processor is further configured to, following providing the response: track a user action; determine a credibility score based on the tracked user action; and store the credibility score for improving future query responses. In some embodiments, the processor is further configured to generate the at least one alternative query by: separating the user query into two or more sub-queries; for each sub-query: identifying a domain-specific synonym; and generating the alternative query using the domain-specific synonym. In some embodiments, the processor is further configured determine the data domain of the user query based on at least one of (a) keywords identified in the user query or (b) a user selection.

In another aspect, the present disclosure provides a method, comprising, by at least one processor: receiving a user query associated with a data domain; determining, for at least one term or phrase in the user query, a domain-specific synonym associated with the data domain; generating at least one alternative query comprising a rewording of all or a portion of the user query using the domain-specific synonym; determining a subset of available data sources to search based at least in part on the data domain; determining, by searching the subset of the available data sources, a set of files relevant to at least one of (i) the user query or (ii) the at least one alternative query; identifying portions of the set of files relevant to at least one of the user query or the at least one alternative query; generating a natural language response based on the relevant portions of the set of files; and providing a response to the user query, the response comprising the natural language response and at least one citation to the relevant portions of the set of files.

In some embodiments, the method further comprises: predicting a goal associated with the user query; and determining the subset of available data sources to search based at least in part on the data domain and the predicted goal. In some embodiments, the method further comprises: determining a credibility score for each data source based on past search results; and determining the subset of available data sources to search based at least in part on the data domain and the credibility score of each data source. In some embodiments, the method further comprises determining the set of files from the subset of available data sources as a ranked list based on the credibility score of the data source from which each file of the set of files was obtained. In some embodiments, the method further comprises determining the credibility score for each data source based on actions taken by user after previous results were provided based on information from the data source.

In some embodiments, the method further comprises segmenting each file in the set of files into chunks, each chunk comprising information associated with a predefined context. In some embodiments, the method further comprises, following providing the response: tracking a user action; determining a credibility score based on the tracked user action; and storing the credibility score for improving future query responses. In some embodiments, the method further comprises generating the at least one alternative query by: separating the user query into two or more sub-queries; for each sub-query: identifying a domain-specific synonym; and generating the alternative query using the domain-specific synonym. In some embodiments, the method further comprises determining the data domain of the user query based on at least one of (a) keywords identified in the user query or (b) a user selection.

In another aspect, the present disclosure provides a non-transitory computer-readable storage medium containing program instructions for causing at least one processor to perform a method of: receiving a user query associated with a data domain; determining, for at least one term or phrase in the user query, a domain-specific synonym associated with the data domain; generating at least one alternative query comprising a rewording of all or a portion of the user query using the domain-specific synonym; determining a subset of available data sources to search based at least in part on the data domain; determining, by searching the subset of the available data sources, a set of files relevant to at least one of (i) the user query or (ii) the at least one alternative query; identifying portions of the set of files relevant to at least one of the user query or the at least one alternative query; generating a natural language response based on the relevant portions of the set of files; and providing a response to the user query, the response comprising the natural language response and at least one citation to the relevant portions of the set of files. In some embodiments, the method further comprises: predicting a goal associated with the user query; and determining the subset of available data sources to search based at least in part on the data domain and the predicted goal.

### BRIEF DESCRIPTION OF DRAWINGS

The present system is illustrated by way of example and not limited in the figures of the accompanying drawings in which like references indicate similar elements.

FIG. 1 is a system-level diagram of a query response system, according to embodiments of this disclosure.

FIG. 2 is a diagram depicting exemplary processing hardware for implementing the system of FIG. 1.

### DETAILED DESCRIPTION

The following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. The following detailed description is therefore not to be taken in a limiting sense, and the scope of the present disclosure is defined by the appended claims and their equivalents.

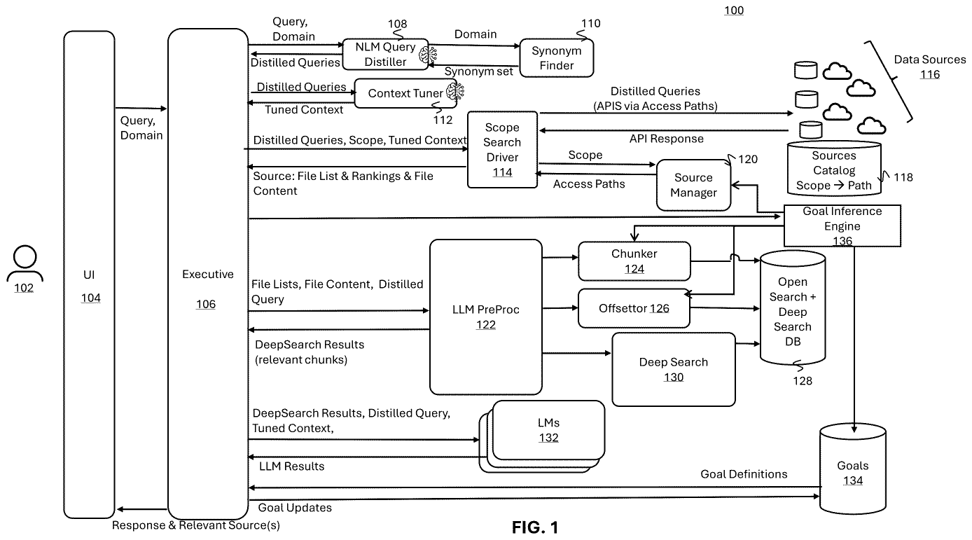

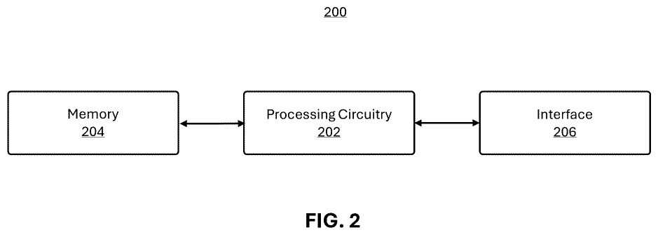

FIG. 1 illustrates an exemplary system 100 of the present disclosure. The system 100 includes a user interface (UI) 104, an executive component 106, a natural language model (NLM) query distiller 108, a synonym finder 110, a context tuner 112, a scope search driver 114, a source manager 120, an LLM preprocessor 122, a chunker 124, an offsettor 126, a database 128, a deep search component 130, a goals database 134, and a goal inference engine 136. Arrows in FIG. 1 illustrate how information may flow through the system 100 from an initial query from a user 102 to a final response presented to the user 102. The system 100 provides solutions to problems of previous technology, as described above and below, by facilitating the generation of more accurate, relevant, and context-aware responses across various data domains. Example hardware for implementing components of the system 100, including, for example, a user device for hosting and displaying the UI 104 and one or more computers and/or servers for implementing the various other system components, is illustrated in FIG. 2 and described in greater detail below.

The UI 104 provides an entry point for queries from a user 102 and displays or otherwise presents corresponding responses. The UI 104 handles query input in a natural language, domain selection and/or detection, and presentation of responses with relevant source citations. In some embodiments, the UI 104 receives user feedback or collects other data for system improvement, such as by tracking user actions for a time to determine response quality. The UI 104 may be presented on a display of a user device, such as a computer, smartphone, tablet, or the like and/or may be provided through an audio device (e.g., a smart speaker).

In operation, the UI 104 receives a user query associated with a data domain. The data domain corresponds to the context or type of information being requested in the query. Example data domains include medical, health, insurance, tax, and human resources domains. However, any data domain may be defined for a given use scenario. The data domain may be indicated by the user 102 or may be automatically detected, for example, based on one or more keywords identified in the user's query.

The executive component 106 acts as a front-end query processor. For example, the executive component 106 may receive and route user queries to various other system components (as described further below), coordinate actions and tasks between these system components, and manage the sequence of operations from query receipt to response generation. The executive component 106 may collect and apply system parameters to improve responses over time. In some embodiments, the executive component 106 engages with users via the UI 104 to clarify their intent, setting the stage for accurate retrieval.

The NLM query distiller 108 breaks the queries into different parts for better understanding using natural language processing (NLP) techniques and synonyms obtained from the synonym finder 110. The synonym finder 110 identifies relevant synonyms for the query based on the data domain as well as synonyms for adjectival and verbal modifiers. For example, the synonym finder 110 may determine, for at least one term or phrase in the user's query, a domain-specific synonym associated with the data domain. For instance, the synonym finder 110 may identify alternate terms for key concepts in the query and use knowledge about the data domain to identify specialized terminology that would otherwise be overlooked for generating responses using previous technology. Each domain may have a predefined list of synonyms. Synonyms may be any part of speech. For instance, synonym may include domain-specific nouns, adjectives, and verbs. Synonyms may also or alternatively be general (e.g., not necessarily specific to a domain). For instance, for the original search term “top ranked”, the synonym finder may identify the synonym “best”. The synonym finder 110 may return a set of synonyms relevant to the domain (or a truncated list relevant to terms in the query) for use by the NLM query distiller 108. In this way, the synonym finder 110 improves query expansion with domain-specific terminology and improves coverage of relevant information sources.

The NLM query distiller 108 uses the synonyms at least in part to generate distilled queries, which include alternative queries based at least in part on the synonyms. The NLM query distiller 108 may break or separate the query into two or more sub-queries. For instance, for each sub-query one or more domain-specific and/or general synonyms may be identified if the sub-query includes a term or phrase with a synonym. One or more distilled or alternative queries are then generated using the domain-specific and/or general synonym(s). The distilled or alternative queries may include a rewording of all or a portion of the user's query using one or more of the domain specific and/or general synonym(s) from the synonym finder 110. Examples of distilled or alternative queries are provided below with respect to an example operation of the system 100. This approach improves technology by enabling the handling of complex, domain-specific queries. Previous technology is often unable to reliably handle such queries.

The context tuner 112 adapts search parameters to specific data domains (e.g., medical, human resources (HR), tax, etc.), helping to ensure relevant data sources 116 are searched, while also providing improved efficiency by preventing searches of non-relevant data sources 116. The context tuner 112 may adjust search parameters based on the data domain and may further optimize the distilled or alternative queries for more effective searching. The context tuner 112 may provide a tuned context to the language models (LMs) 132 for more accurate responses. For example, the tuned context may include contextual information about the query in addition to the query's data domain (e.g., a sub-domain of the data domain, such as a benefits sub-domain in the overall data domain of HR). In this way, the context tuner 112 may adapt to different knowledge domains through dynamic parameter adjustment.

The scope search driver 114 acts as a preliminary information filter, efficiently narrowing down relevant sources from amongst the available data sources 116. For example, the scope search driver 114 may manage high-level search strategy by executing the distilled or alternative queries against appropriate data sources 116, combining and normalizing results from these multiple queries, and managing search scope to improve result relevance and system performance. This process results in the determination of a subset of the data sources 116 to search. A file list of these search results are provided to the LLM preprocessor 122. This file list may be ranked based on relevance and/or based on source credibility, as described further below.

The data sources 116 searched in this process are any sources of data relevant to the data domains that the system 100 is configured to search. As such, the data sources 116 may be variable based on the use scenario of the system 100. For instance, the data sources 116 may include specialized and trusted repositories of information related to the relevant data domains handled by the system 100. In this way, results may be improved over previous technologies by limiting searches to pre-approved data sources 116 that are known to be reliable rather than relying on crowdsourced information from the internet or other potentially unreliable sources.

The source manager 120 enhances the system's ability to find and utilize diverse, relevant data sources 116. The source manager 120 may maintain a sources catalog 118 of available data sources 116. The source manager 120 may assign scope paths to different data sources 116, which act as information repositories, as described above. The source manager 120 may provide access paths to the scope search driver 114 (e.g., to efficiently and reliably access the data sources 116). The source manager 120 may track data source credibility and relevance to different data domains and/or maintain domain-specific credibility scores for each data source 116. For example, the source manager 120 may determine a credibility score for each data source 116. The credibility score may be based on past search results, as described further below. The scope search driver 114 may select a subset of data sources 116 to search using these credibility scores. For instance, the ranked file list identified by the scope search driver 114 may be determined based at least in part on the credibility scores of the data sources 116.

The LLM preprocessor 122 prepares information for effective retrieval and integration by the LMs 132. The LLM preprocessor 122 may process file lists and content from the scope search driver 114, route content to the chunker 124 and offsettor 126, and manage content preparation for use by the deep search component 130. The LLM preprocessor 122 may handle file parsing and format conversion. The LLM preprocessor 122 helps to ensure optimal data understanding and integration.

The chunker 124 and offsettor 126 work together to break down and precisely locate information for accurate responses. The chunker 124 segments each file in the set of files into chunks, such that each chunk includes information associated with a predefined context. The offsettor 126 generates offset information for source attribution. The resulting segmented data with offsets and source attribution are stored in database 128, which is used by the deep search component 130. By limiting the search to database 128, the deep search component 130 can be implemented more efficiently than was possible using previous technology (e.g., more efficiently than if all available data were searched without preprocessing).

The chunker 124 may use dynamic chunk sizing based on data content and the data domain, such that semantic boundaries are preserved when files are segmented by the chunker 124. In other words, portions of files or documents describing a given concept are retained in the same chunk or segment. In some embodiments, overlapping chunks are generated to maintain context. These features may provide technological improvements over previous data segmentation approaches, which can often result in information related to the same concept being separated into different chunks, such that these concepts are difficult to search. For instance, using previous technology, content relevant to the user's query may be segmented into multiple chunks, such that LMs are less able to reliably use this segmented information to create a useful response. The present system 100 solves such problems.

The deep search component 130 performs comprehensive retrieval on the most promising sources that are identified by the scope search driver 114 and stored in a preprocessed form by the chunker 124 and offsettor 126 in database 128. The deep search component 130 executes a semantic search against the content in database 128 and identifies the most relevant content chunks (e.g., the portions of the files relevant to the user's query and/or the distilled or alternative queries). The results are provided to the executive component 106. The results may be ranked based on relevance and/or the credibility score of the data source 116 from which the results were obtained.

The LMs 132 generate a coherent natural language response based on relevant portions of the files identified by the deep search component 130. The response is grounded in the retrieved information and maintains attribution or citation to the corresponding source data 116. The citation may be to a specific paragraph, line, page number, etc. in the source data 116. As explained further below, the response may be adapted based on the user's inferred goal and/or the domain of the query. The response is provided to the user 102 via the UI 104.

The goals inference engine 136 maintains a goals database 134, such that the system 100 can learn and improve based on past interactions. While processing a query, the goals inference engine 136 infers a goal associated with the user's query. One or more neural networks may be used to derive one or more inferred goals from the distilled or alternative queries. The inferred goal may help guide the selection of data sources 116 to search, the segmentation of selected files into chunks, and/or the formatting of a natural language response to the query. In this way, the goals inference engine 136 may map user queries to likely user intents and goals. The goals inference engine 136 may employ neural networks to derive goals from the distilled or alternative queries determined by the NLM query distiller 108. The goals inference engine 136 may map queries to specific goals within domains (e.g., “Apply for FMLA” in the HR domain for the example provided below).

The goals inference engine 136 maintains a goals database 134 of domain-goal-action relationships with weighted outcomes of previous queries. The goals inference engine 136 may track parameters that resulted in successful outcomes (e.g., high quality query responses) for past queries and store this information in the goals database 134. Information in the goals database 134 guides the retrieval and response generation to better meet user intentions. For example, the goals database 134 may store successful query-goal-result patterns from previous queries. Information in the goals database 134 may be used as optimization targets for parameter learning. Example adjustable parameters that may be optimized include, for example, chunk size, chunk overlap, deep search list size, etc. A loss function based on points for each run may be used to optimize parameter settings.

In some embodiments, after the response is provided to the UI 104, the system 100 determines a quality score for the response. The quality score may reflect a level of usefulness of the response to the user 102. In some embodiments, the score is based at least in part on tracking actions of the user 102 for a time interval after the response is provided and determining the apparent usefulness of the response based on the user's actions during this time interval. For example, the executive component 106 may track a user action and determine the usefulness of the response based on the action (e.g., whether the user completed their task based on information provided in the response). The credibility score is stored (e.g., in the goals database 134) to improve future query responses. A SourceObjectGradeTable may be used to track the quality of individual objects (e.g., individual lines, paragraphs, chapters, etc. of documents) within the data sources 116. The quality score may be used as the credibility score of the source 116 or to update the credibility score of the source 116.

In an example operation of the system 100, the user 102 provides a query via the UI 104. In this example scenario, the query is “How do I apply for FMLA in my company?” The UI 104 captures the query. The user may enter or select a domain associated with the query (e.g., by selecting the domain from a pulldown menu or through some other means in the UI 104). Alternatively, the domain may be automatically determined or determined by the referring (client) application that is already context-aware. For instance, the domain may be determined based on keywords or phrases detected in the query (e.g., FMLA is a term associated with the HR domain). In this example scenario, the domain is HR.

The executive component 106 receives the query and an indication of the data domain and begins processes for determining a response. The query is routed for refinement through subsequent components of the system 100 and initial system parameters are set. The query may be passed to the NLM query distiller 108, which breaks the query into parts or chunks (e.g., “apply for FMLA” and “in my company”) and expands the query, for example, by identifying the search term “Family Medical Leave Act” corresponding to “FMLA” in the query. The synonym finder 110 provides domain-specific synonyms, such as “FMLA procedure.” A set of distilled queries is then generated (e.g., “How to request FMLA” and “FMLA company policy” for this example search scenario). The context tuner 112 recognizes the HR domain and adjusts search parameters accordingly. The system 100 is then tuned for HR-specific data sources 116 and terminology.

At this stage, the goal inference engine 136 determines an inferred goal of the query. For this example scenario, the inferred goal is “Apply for FMLA leave.” The goal inference engine 136 checks the goals database 134 for similar HR queries (e.g., for queries with the same or a similar goal). The similar queries from the goal database 134 may be used to help guide data retrieval, as described further below.

An initial search strategy is then defined. The executive component 106 directs the scope search driver 114 to start the search process. The scope search driver 114 takes the distilled queries and begins defining a high-level search strategy, determining which sources 116 to target based on the identified HR domain and any inferred goal(s). The executive component 106 then requests relevant sources from the source manager 120.

Sources are then selected and the search is completed. The source manager 120 receives the request, accesses data sources 116 relevant to the HR domain (e.g., company policy documents, government FMLA guidelines, etc.), and assigns credibility scores based on past performances of these sources 116. The scope search driver 114 searches these sources to execute the distilled queries, finding files such as “FMLA Guidelines. pdf” or “Company HR Handbook.” The results may be ranked, such that a ranked list of relevant files is generated and returned to the executive component 106.

Content is then processed and segmented. The LLM preprocessor 122 parses the files. The chunker 124 and offsettor 126 split the files into chunks (e.g., with a chunk corresponding to an “FMLA Eligibility” section of the document file) in a manner that preserves context within the chunks. The deep search component 130 searches the chunks for specific steps to apply for FMLA and ranks the results by relevance. A shortlist of highly relevant chunks is returned.

A coherent, sourced response is then generated using the ranked shortlist determined by the deep search component 130. The LMs 132 may be used to generate the response: “To apply for FMLA at your company, submit a request form to HR with medical certification, per the Company HR Handbook (p. 15).” As shown, this response includes a citation to a particular page in a particular document. The file itself or a link to the file or a website displaying the information may be provided along with the response. The UI 104 provides the response with the source citation.

Feedback and learning may be performed to improve future responses. For example, the user may rate the response, and the goals database 134 may update system parameters accordingly based on this feedback. For instance, if positive feedback is received, the data source(s) 116 used may be given an increased quality score for the goal of “Apply for FMLA leave.” Also or alternatively, one or more subsequent actions of the user 102 may be tracked to determine a quality of the response for updating system parameters. For instance, after the user 102 was instructed how to apply for FMLA via the response, the system 100 may track whether the user 102 takes any relevant actions (e.g., by navigating to website to review page 15 of the company HR handbook, search for the FMLA request form, and/or obtain a medical certification). If a relevant action is taken, the response may be given a higher quality and/or credibility score. User behavior can also trigger a reduction in quality and/or credibility scores, for instance, if a user repeats a query that is substantially the same as a previous question in the same or a slightly different format, the previous responses may have been inappropriate. The system 100 may detect when a query is repeated in such a manner (e.g., with the same or a similar query or with the same or a similar detected goal) and in response decrease the quality score of the original response.

The system 100 addresses limitations of traditional LLMs, which can sometimes generate plausible but incorrect responses. The system 100 improves information accuracy and reliability by grounding responses in up-to-date, factual data. The system 100 also allows real-time knowledge updates without retraining the entire model. The system 100 has an improved contextual understanding and provides more relevant responses by narrowing the data sources actually used by the LMs 132 to the most pertinent information for a given a query. These and other features described above allow the system 100 to handle complex queries. For instance, a conventional LLM might struggle to provide an accurate response to the query “What are the latest WHO guidelines for managing hypertension in chronic kidney disease patients?” Meanwhile, the system 100 can provide specific, up-to-date response to this query by limiting the search to the latest WHO guidelines, while also identifying and including specific blood pressure targets, medication advice, and citations to relevant data sources.

FIG. 2 illustrates an example processing device 200. The processing device 200 or collection of processing devices 200 (e.g., arranged as one or more servers) may be employed to implement one or more components of the system 100 of FIG. 1. The device 200 includes processing circuitry 202, memory 204, and a communications interface 206. The processing circuitry 202 includes one or more processors. The processing circuitry 202 includes any electronic circuitry, such as state machines, one or more central processing unit (CPU) chips, logic units, cores (e.g. a multi-core processor), field-programmable gate array (FPGAs), application-specific integrated circuits (ASICs), digital signal processors (DSPs), neural processing units (NPUs), graphics processing units (GPUs), tensor processing units (TPUs), and/or the like. The processing circuitry 202 may be a programmable logic device, a microcontroller, a microprocessor, or any suitable combination of these or similar devices. The processing circuitry 202 is communicatively coupled to and in signal communication with the memory 204. The one or more processors are configured to process data and may be implemented in hardware and/or software. For example, the processing circuitry 202 may be 8-bit, 16-bit, 32-bit, 64-bit or of any other suitable architecture. The processing circuitry 202 may include an arithmetic logic unit (ALU) for performing arithmetic and logic operations, processor registers that supply operands to the ALU and store the results of ALU operations, and a control unit that fetches instructions from memory 204 and executes them by directing the coordinated operations of the ALU, registers and other components.

The memory 204 includes any logic, instructions, code, and/or rules for implementing the functions of the system 100 of FIG. 1. The memory 204 may include one or more disks, tape drives, or solid-state drives to store programs when such programs are selected for execution and to store instructions and data that are read during program execution. The memory 204 may be volatile or non-volatile and may include, for example, read-only memory (ROM), random-access memory (RAM), ternary content-addressable memory (TCAM), dynamic random-access memory (DRAM), and static random-access memory (SRAM).

The communications interface 206 is configured to enable wired and/or wireless communications between other devices or systems. For example, the communications interface 206 may include a network interface, such as a Wi-Fi interface, a local area network (LAN) interface (e.g., an ethernet interface), a wide area network (WAN) interface, a modem, a switch, a router. The communications interface 206 may include a hardware interface, such as Universal Serial Bus (USB) interface, a parallel interface, and the like. The processing circuitry 202 may send and receive data using the communications interface 206. The communications interface 206 may be configured to use any suitable type of communication protocol.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter, e.g., for applications suitable for public and private sectors. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the claims in the non-provisional application claiming priority to this provisional application.

1: A system comprising at least one processor configured to:
receive a user query associated with a data domain;
determine, for at least one term or phrase in the user query, a domain-specific synonym associated with the data domain;
generate at least one alternative query comprising a rewording of all or a portion of the user query using the domain-specific synonym;
determine a user-intent goal associated with the user query, the user-intent goal inferred from user-specific contextual data or prior user interactions and representing the user's purpose;
determine a subset of available data sources to search based at least in part on the data domain and the inferred user-intent goal;
determine, by searching the subset of the available data sources, a set of files relevant to at least one of (i) the user query or (ii) the at least one alternative query;
identify portions of the set of files relevant to at least one of the user query or the at least one alternative query;
generate a natural language response based on the relevant portions of the set of files; and
provide a response to the user query, the response comprising the natural language response and citations to the relevant portions of the set of files.

2: The system of claim 1, wherein the processor is further configured to:
predict a goal associated with the user query; and
determine the subset of available data sources to search based at least in part on the data domain and the predicted goal.

3: The system of claim 1, wherein the processor is further configured to:
determine a credibility score for each data source based on past search results; and
determine the subset of available data sources to search based at least in part on the data domain and the credibility score of each data source.

4: The system of claim 3, wherein the processor is further configured to determine the set of files from the subset of available data sources as a ranked list based on the credibility score of the data source from which each file of the set of files was obtained.

5: The system of claim 3, wherein the processor is further configured to determine the credibility score for each data source based on actions taken by user after previous results were provided based on information from the data source.

6: The system of claim 1, wherein the processor is further configured to segment each file in the set of files into chunks, each chunk comprising information associated with a predefined context.

7: The system of claim 1, wherein the processor is further configured to, following providing the response:
track a user action;
determine a credibility score based on the tracked user action; and
store the credibility score for improving future query responses.

8: The system of claim 1, wherein the processor is further configured to generate the at least one alternative query by:
separating the user query into two or more sub-queries;
for each sub-query:
identifying a domain-specific synonym; and
generating the alternative query using the domain-specific synonym.

9: The system of claim 1, wherein the processor is further configured to determine the data domain of the user query based on at least one of (a) keywords identified in the user query or (b) a user selection.

10: A method, comprising, by at least one processor:
receiving a user query associated with a data domain;
determining, for at least one term or phrase in the user query, a domain-specific synonym associated with the data domain;
generating at least one alternative query comprising a rewording of all or a portion of the user query using the domain-specific synonym;
determining a user-intent goal associated with the user query, the user-intent goal inferred from user-specific contextual data or prior user interactions and representing the user's purpose;
determining a subset of available data sources to search based at least in part on the data domain and the inferred user-intent goal;
determining, by searching the subset of the available data sources, a set of files relevant to at least one of (i) the user query or (ii) the at least one alternative query;
identifying portions of the set of files relevant to at least one of the user query or the at least one alternative query;
generating a natural language response based on the relevant portions of the set of files; and
providing a response to the user query, the response comprising the natural language response and at least one citation to the relevant portions of the set of files.

11: The method of claim 10, further comprising:
predicting a goal associated with the user query; and
determining the subset of available data sources to search based at least in part on the data domain and the predicted goal.

12: The method of claim 10, further comprising:
determining a credibility score for each data source based on past search results; and
determining the subset of available data sources to search based at least in part on the data domain and the credibility score of each data source.

13: The method of claim 12, further comprising determining the set of files from the subset of available data sources as a ranked list based on the credibility score of the data source from which each file of the set of files was obtained.

14: The method of claim 12, further comprising determining the credibility score for each data source based on actions taken by user after previous results were provided based on information from the data source.

15: The method of claim 10, further comprising segmenting each file in the set of files into chunks, each chunk comprising information associated with a predefined context.

16: The method of claim 10, further comprising, following providing the response:
tracking a user action;
determining a credibility score based on the tracked user action; and
storing the credibility score for improving future query responses.

17: The method of claim 10, further comprising generating the at least one alternative query by:
separating the user query into two or more sub-queries;
for each sub-query:
identifying a domain-specific synonym; and
generating the alternative query using the domain-specific synonym.

18: The method of claim 10, further comprising determining the data domain of the user query based on at least one of (a) keywords identified in the user query or (b) a user selection.

19: A non-transitory computer-readable storage medium containing program instructions for causing at least one processor to perform a method of:
receiving a user query associated with a data domain;
determining, for at least one term or phrase in the user query, a domain-specific synonym associated with the data domain;
generating at least one alternative query comprising a rewording of all or a portion of the user query using the domain-specific synonym;
determining a user-intent goal associated with the user query, the user-intent goal inferred from user-specific contextual data or prior user interactions and representing the user's purpose;
determining a subset of available data sources to search based at least in part on the data domain and the inferred user-intent goal;
determining, by searching the subset of the available data sources, a set of files relevant to at least one of (i) the user query or (ii) the at least one alternative query;
identifying portions of the set of files relevant to at least one of the user query or the at least one alternative query;
generating a natural language response based on the relevant portions of the set of files; and
providing a response to the user query, the response comprising the natural language response and at least one citation to the relevant portions of the set of files.

20: The non-transitory computer-readable storage medium of claim 19, wherein the method further comprises:
predicting a goal associated with the user query; and
determining the subset of available data sources to search based at least in part on the data domain and the predicted goal.
